(19) United States
(12) Patent Application Publication
(10) Pub. No.: US 2017/0158200 A1
(43) Pub. Date: Jun. 8, 2017

(54) METHOD AND ELECTRONIC DEVICE FOR SAFE-DRIVING DETECTION

(71) Applicants: LE HOLDINGS (BEIJING) CO., LTD., Beijing (CN); LEMOBILE INFORMATION & TECHNOLOGY (BEIJING) CO., LTD., Beijing (CN)

(72) Inventors: Kai WU, Beijing (CN); Li LI, Beijing (CN)

(21) Appl. No.: 15/244,654

(22) Filed: Aug. 23, 2016

Related U.S. Application Data
(63) Continuation of application No. PCT/CN2016/088696, filed on Jul. 5, 2016.

(30) Foreign Application Priority Data
Dec. 8, 2015 (CN) 201510897839.4

(51) Int. Cl. B60W 30/18; G06T 7/20; H04N 5/232; H04N 7/18; G06K 9/00; G06T 11/60

(52) U.S. Cl. CPC B60W 30/18163; G06K 9/00805; G06T 11/60; H04N 5/23293; H04N 7/181; G06T 7/20; G06T 2207/30261; B60W 2420/42; B60W 2720/106

(57) ABSTRACT

Embodiments of the present disclosure disclose a safe-driving detection method and device, where the method includes: performing image capturing preview on an exterior of a host vehicle from an interior of the host vehicle by employing a first image capturing device provided on a mobile terminal; performing distance recognition on an object in a preview image by employing an infrared laser focusing function of the first image capturing device; and performing driving information prompt on the host vehicle according to a recognition result. The embodiments of the present disclosure can be suitable for safe-driving detection of most vehicles and have general applicability.

### CROSS-REFERENCES TO RELATED APPLICATIONS

The present application is a continuation of International Application No. PCT/CN2016/088696, filed on Jul. 5, 2016, which is based upon and claims priority to Chinese Patent Application No. 201510897839.4, filed on Dec. 8, 2015, the entire contents of which are incorporated herein by reference.

### TECHNICAL FIELD

The present disclosure relates to the technical field of intelligent vehicle driving, for example, relates to a method and device for safe-driving detection.

### BACKGROUND

With the continuous increasing of vehicles in our nation, they have entered into thousands of families. When bringing convenience to people' trip, the vehicles may continuously increase an incidence for traffic accident. Overtaking and fatigue driving are relatively common behaviors during a driving process. For example, as for the overtaking, within a short overtaking time, since it is hard for a driver to observe conditions of all vehicles at the surrounding environment and predict a moving trajectory of a preceding vehicle, traffic accidents easily occur during an overtaking process.

Mounting a trip computer in the vehicle and mounting an infrared laser distance measuring equipment to match the whole vehicle can reduce the incidence of the traffic accident during the overtaking and fatigue driving. However, in parts of vehicles which are not equipped with trip computers and infrared laser distance measuring equipment, a prompt for the overtaking and fatigue driving is hardly achieved. Moreover, the trip computer is expensive in cost without freely general applicability.

### SUMMARY

Embodiments of the present disclosure provide a method and electronic device for safe-driving detection, which may be suitable for safe-driving detection of most vehicles and have general applicability.

In a first aspect, an embodiment of the present disclosure provides a method for safe-driving detection, including:

performing image capturing preview on an exterior of a host vehicle from an interior of the host vehicle by employing a first image capturing device provided on a mobile terminal;

performing distance recognition on an object in a preview image by employing an infrared laser focusing function of the first image capturing device; and

performing driving information prompt on the host vehicle according to a recognition result.

In a second aspect, an embodiment of the present disclosure further provides an electronic device for safe-driving detection, including: at least one processor and a memory communicably connected with the at least one processor for storing instructions executable by the at least one processor, wherein execution of the instructions by the at least one processor causes the at least one processor to:

perform image capturing preview on an exterior of a host vehicle from an interior of the host vehicle by employing a first image capturing device provided on a mobile terminal;

perform distance recognition on an object in a preview image by employing an infrared laser focusing function of the first image capturing device; and

perform driving information prompt on the host vehicle according to a recognition result.

In a third aspect, an embodiment of the present disclosure further provides a non-transitory computer-readable storage medium storing executable instructions that, when executed by an electronic device, cause the electronic device to:

perform image capturing preview on an exterior of a host vehicle from an interior of the host vehicle by employing a first image capturing device provided on a mobile terminal;

perform distance recognition on an object in a preview image by employing an infrared laser focusing function of the first image capturing device; and

perform driving information prompt on the host vehicle according to a recognition result.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1A is a schematic flow diagram of a safe-driving detection method according to some embodiments of the present disclosure;

FIG. 1B is a schematic diagram showing a placement position of a mobile terminal in a safe-driving detection method according to some embodiments of the present disclosure;

FIG. 1C is a schematic diagram showing viewable areas of a rearview mirror and a reflective mirror of a host vehicle in a safe-driving detection method according to some embodiments of the present disclosure;

FIG. 1D is a schematic diagram showing partition display of an image capturing preview area in a safe-driving detection method according to some embodiments of the present disclosure;

FIG. 1E is a schematic diagram showing an application scene in a safe-driving detection method according to some embodiments of the present disclosure;

FIG. 1F is a schematic diagram showing a movement distance calculating method in a safe-driving detection method according to an embodiment 1 of the present disclosure;

FIG. 1G is a schematic diagram of an overtaking indication line in a safe-driving detection method according to some embodiments of the present disclosure;

FIG. 2 is a schematic diagram showing a structure of a safe-driving detection device according to some embodiments of the present disclosure; and

FIG. 3 is a schematic diagram showing a structure of hardware of a mobile terminal according to some embodiments of the present disclosure.

### DETAILED DESCRIPTION

The present disclosure will be described in detail below in conjunction with accompanying drawings and embodiments. It should be understood that the embodiments described herein are merely used for explaining the present disclosure, but not limiting the present disclosure. In addition, it is also noted that, for easy of description, relevant structures, rather than all structures, related to the present disclosure are merely shown in the accompanying drawings.

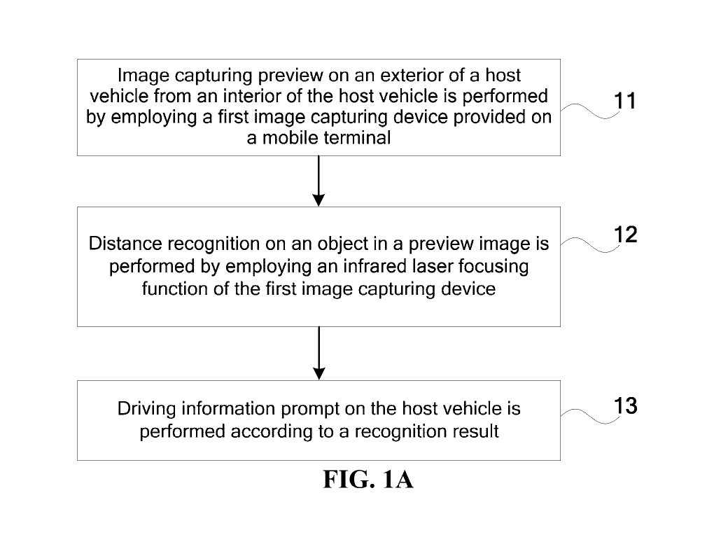

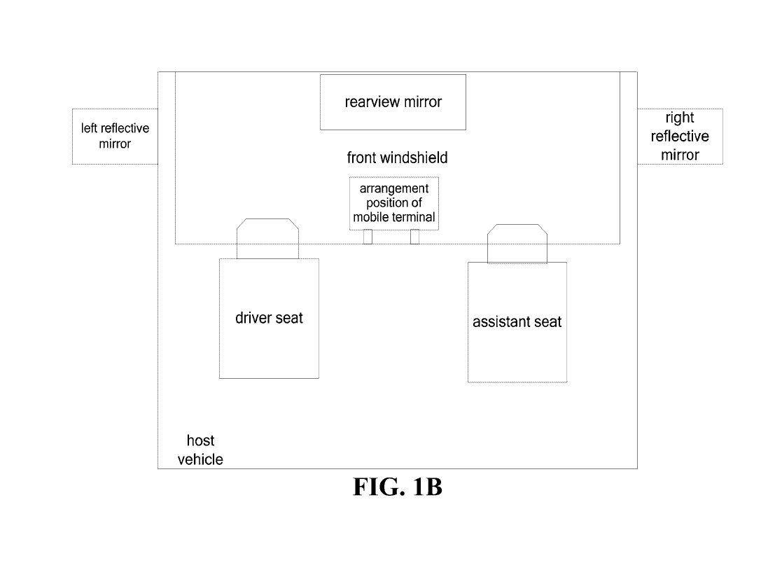

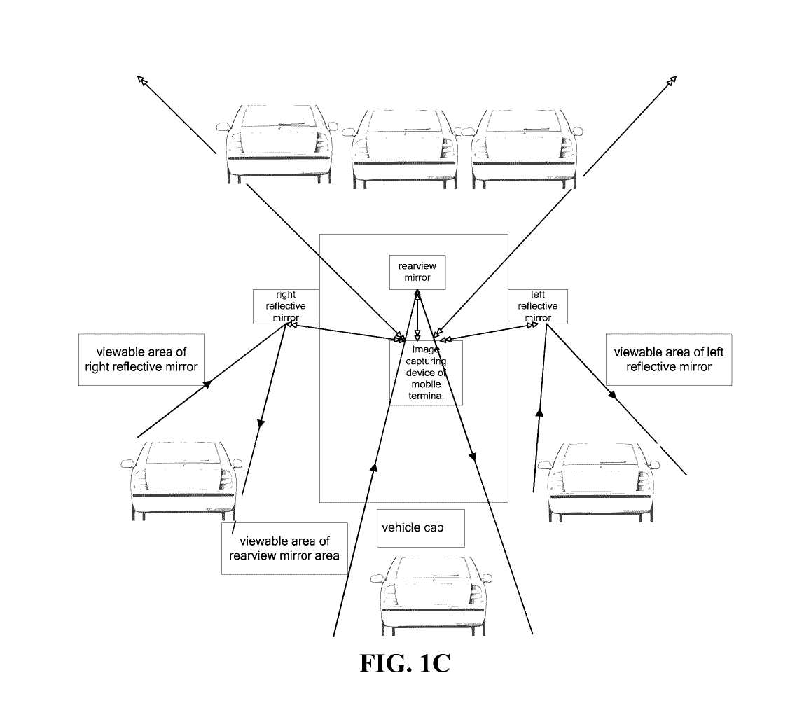

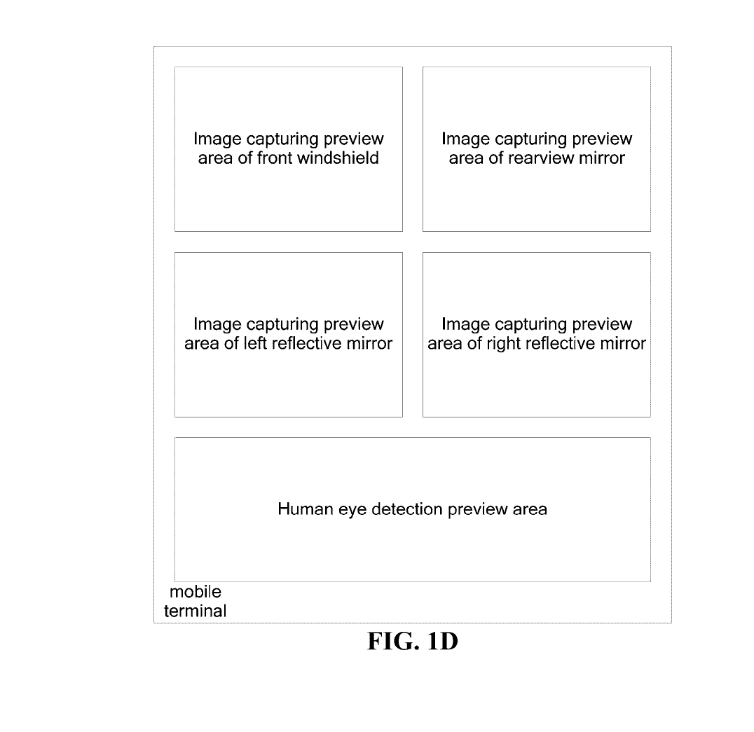

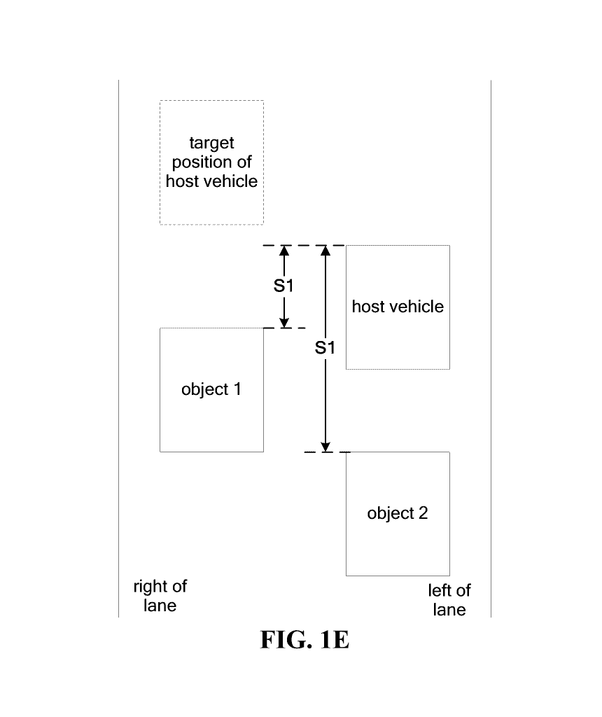

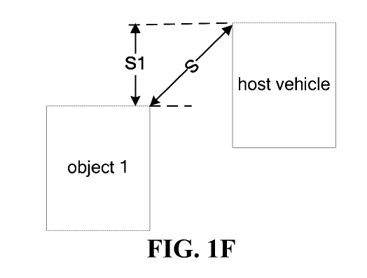

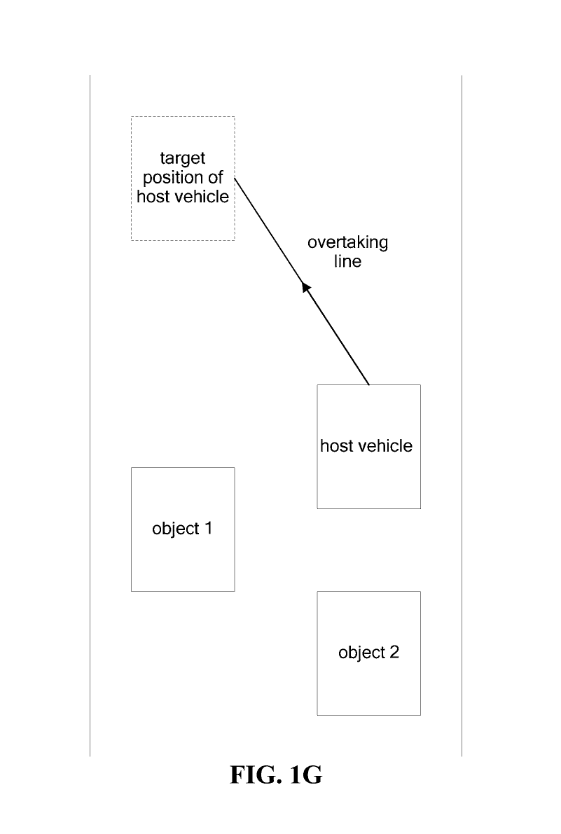

FIG. 1A is a schematic flow diagram of a safe-driving detection method according to some embodiments of the present disclosure. In the embodiment, an executive object may be a device for safe-driving detection provided in the embodiment of the present disclosure or a mobile terminal integrated with the device for safe-driving detection, for example, a smart phone, a tablet personal computer or the like. In order to save cost, the safe-driving detection device may be implemented in a software manner, that is, the safe-driving detection device can be made into an application client installed on the mobile terminal so as to have more general applicability. As shown in FIG. 1A:

In Step 11, image capturing preview on an exterior of a host vehicle from an interior of the host vehicle is performed by employing a first image capturing device provided on a mobile terminal;

Wherein the mobile terminal at least is provided with one first image capturing device, that is, a camera, and the first image capturing device has an infrared laser focusing function so as to perform the image capturing preview on the exterior of the host vehicle. A picture of the image capturing preview may be directly displayed on a display screen built in the mobile terminal.

Optionally, a user may in advance mount the safe-driving detection device provided by the embodiment of the present disclosure into the mobile terminal, and initiate the safe-driving detection device when the safe-driving detection is required to be performed, and the safe-driving detection device may directly invoke the image capturing device in the mobile terminal for imaging monitoring after being initiated.

In Step 12, distance recognition on an object in a preview image is performed by employing an infrared laser focusing function of the first image capturing device;

Wherein the object in the preview image may be selected from at least one of the following: other vehicles running in front, rear, left, right, front-left, front-right, rear-left or rear-right of the host vehicle, a notice board or a handrail.

Particularly, since infrared rays has a less refractive index when passing through other substances and imaged picture is relatively clear, image capturing devices of most mobile terminals may employ the infrared rays to perform long-distance image capturing. Therefore, in the embodiment, the infrared laser focusing function of the image capturing device in the mobile terminal can be directly utilized to directly obtain a relative distance of the object in the preview image from the host vehicle. Particularly, since propagation of the infrared rays requires a certain period of time, when radiated from the image capturing device and reflected back after colliding with a reflector, the infrared rays are received by the image capturing device. Then, a distance between the reflector and the image capturing device can be calculated according to time from radiating to receiving of the infrared rays and a propagation velocity of the infrared rays, thereby using the above distance as a distance between the object in the preview image and the host vehicle.

In Step 13, driving information prompt on the host vehicle is performed according to a recognition result.

Wherein the driving information prompt includes at least one of voice prompt, text prompt and picture prompt.

Optionally, the driving information prompt may be performed according to the distance, which is obtained in step 12, between the object and the host vehicle in the preview image. For example, a user is prompted to overtake or not, and the like.

In the embodiment, performing image capturing preview on the exterior of the host vehicle from an interior of the host vehicle by employing the first image capturing device provided on a mobile terminal; performing distance recognition on an object in a preview image by employing an infrared laser focusing function of the first image capturing device; and performing driving information prompt on the host vehicle according to a recognition result. In this way, the safe-driving detection is completed by using a mobile terminal, without mounting a high-cost specialized driving detection device in a host vehicle. Therefore, the embodiment can be suitable for safe-driving detection of most vehicles and have general applicability.

Exemplarily, on the basis of the above embodiment, the performing image capturing preview on an exterior of a host vehicle from an interior of the host vehicle by employing a first image capturing device provided on a mobile terminal includes:

capturing an image of at least one of a front windshield, a rearview mirror and a reflective mirror from an interior of the host vehicle by employing a first image capturing device provided on a mobile terminal so as to perform image capturing preview on the exterior of the host vehicle.

Exemplarily, on the basis of the above embodiment, in order to facilitate the user more visually to view a running condition of the object external to the host vehicle in each direction, the method includes:

dividing a display screen of the mobile terminal into at least two image capturing preview areas relative to objects external to a host vehicle in multiple directions of the host vehicle so as to realize respective monitoring on the objects external to the host vehicle in the multiple directions of the host vehicle.

Wherein the multiple directions include right front, front-left, front-right, right rear, rear-left and rear-right.

Optionally, as shown in FIG. 1B and FIG. 1C, the user may place the mobile terminal in a suitable position in the host vehicle, so that the image capturing device of the placed mobile terminal can capture pictures from a front windshield, a rearview mirror, a left reflective mirror and a right reflective mirror. Wherein the rearview mirror is positioned above the front of a driver seat and an assistant seat in the host vehicle to image an object behind the host vehicle; the left reflective mirror and the right reflective mirror are respectively located at a left position and a right position in the front of the exterior of the host vehicle, and respectively used to image objects in rear-left and rear-right of the host vehicle.

As shown in FIG. 1D, an image capturing preview area of the front windshield, an image capturing preview area of the rearview mirror, an image capturing preview area of the left reflective mirror and an image capturing preview area of the right reflective mirror are respectively displayed on a display screen of the mobile terminal. Wherein the image capturing preview area of the front windshield is used to monitor objects right in front, in front-left and in front-right of the exterior of the host vehicle; the image capturing preview area of the rearview mirror is used to monitor the object in rear of the exterior of the host vehicle; the image capturing preview area of the left reflective mirror is used to monitor an object in rear-left of the exterior of the host vehicle; and the image capturing preview area of the right reflective mirror is used to monitor an object in rear-right of the exterior of the host vehicle.

Exemplarily, on the basis of the above embodiment, the performing distance recognition on an object in a preview image by employing the infrared laser focusing function of the first image capturing device may include two implementations, a first implementation includes:

obtaining a movement distance of an object external to a host vehicle in at least one direction relative to the host vehicle from the preview image periodically by employing an infrared laser focusing function of the first image capturing device; and

determining, according to a relationship between a difference between at least one movement distance obtained periodically and a preset overtaking difference, whether the host vehicle can overtake as a recognition result.

Wherein the periodicity may be set to a preset time interval. For example, a movement distance of the object external to the host vehicle in at least one direction relative to the host vehicle is obtained from the preview image every other 1 second or 5 seconds. In the embodiment, the obtained direction of the movement distance, for example, a movement distance S1 as shown in FIG. 1E, is required along a driving direction of the host vehicle. As shown in FIG. 1F. If the direction of the movement distance S obtained by the infrared laser focusing function of the first image capturing device is inconsistent with the driving direction of the host vehicle, as shown in FIG. 1F, it is required to decompose the movement distance S to obtain a component which is in the driving direction of the host vehicle, i.e. the movement distance S1, and the specific value of the movement distance S1 in the driving direction of the host vehicle is obtained by calculation.

Optionally, taking an application scene shown in FIG. 1E as an example, when the host vehicle is ready to overtake from the left of a lane to the right of the lane, it is required to detect objects positioned in front, rear and right of the host vehicle; when the obtained movement distance S1 of the objects positioned in three directions external to the host vehicle relative to the host vehicle is greater than a preset distance (for example, 100 m), it is determined that the host vehicle can overtake, then the user is prompted by voice to overtake, otherwise, is prompted by voice not to overtake.

Or, in order to increase a safety factor, the movement distance S1 of the object in each direction relative to the host vehicle may be measured for multiple times, then differences between the multiple movement distances S1 are compared, and when the maximal difference is less than a preset overtaking difference, it is determined that the host vehicle can overtake, otherwise, it is determined that the host vehicle can not overtake.

Exemplarily, on the basis of the above embodiment, a second implementation of performing distance recognition on an object in a preview image by employing an infrared laser focusing function of the first image capturing device includes:

obtaining a movement distance of an object external to a host vehicle in at least one direction relative to the host vehicle within a first preset time period from the preview image by employing an infrared laser focusing function of the first image capturing device; and

determining a movement velocity of the object external to the host vehicle according to the movement distance, and determining, according to the movement velocity of the object external to the host vehicle, whether the host vehicle can overtake or not as a recognition result.

Optionally, detecting a first distance S1 of the object external to the host vehicle relative to the host vehicle at a first time T1 by firstly employing an infrared laser focusing function of the first image capturing device; continuously detecting a corresponding second time T2 when the object external to the host vehicle moves to a second distance S2 relative to the host vehicle by employing an infrared laser focusing function of the first image capturing device; then obtaining a movement distance (S2−S1) of the object external to the host vehicle in at least one direction relative to the host vehicle within a time period (T2−T1) by calculation. Therefore, a movement velocity of the object external to the host vehicle is determined according to the movement distance, and whether the host vehicle can overtake or not is determined according to the movement velocity of the object external to the host vehicle. The determination process includes:

when the object external to the host vehicle is in front of the host vehicle, calculating a relative velocity V2 of the object external to the host vehicle according to the first time T1, the first distance S1, the second distance S2 and the second time T2, that is,

$$V 2 = \frac{S 2 - S 1}{T 2 - T 1} ;$$

if the velocity V2 is a positive value and greater than or equal to a first preset velocity threshold, determining that the host vehicle can overtake; and if the velocity V2 is a positive value and less than the preset velocity threshold or the velocity V2 is a negative value and an absolute value of the velocity V2 is less than the first preset velocity threshold, determining that the host vehicle cannot overtake.

Or, when the object external to the host vehicle is in rear of the host vehicle, calculating a relative velocity V2 of the object external to the host vehicle according to the first time T1, the first distance S1, the second distance S2 and the second time T2, that is,

$$V 2 = \begin{matrix}S 2 - S 1 \\ T 2 - T 1\end{matrix} ;$$

if the velocity V2 is a negative value and an absolute value of the velocity V2 is less than or equal to a second preset velocity threshold, determining that the host vehicle can overtake; and if the velocity V2 is a positive value or the velocity V2 is a negative value and an absolute value of the velocity V2 is greater than the second preset velocity threshold, determining that the host vehicle cannot overtake.

In addition, it is noted that in order to increase a safety factor, when whether the host vehicle overtakes or not is determined according to the velocity V2, whether the host vehicle can overtake or not may be determined according to the obtained movement distance (S2−S1). That is, when the above overtaking condition associated with velocity is met, and when an absolute value of the difference value of the movement distance (S2−S1) is less than a preset overtaking difference, it is determined that the host vehicle can overtake; and when the absolute value of the difference value of the movement distance (S2−S1) is greater than or equal to the preset overtaking difference, it is determined that the host vehicle cannot overtake.

The above implementation may obtain the velocity of the host vehicle by identification of an instrument panel, or obtain the velocity of the host vehicle by interacting with a control device of the host vehicle, or position identification can also be performed by the mobile terminal to further calculate a movement velocity of the mobile terminal itself as the velocity of the host vehicle. Whether the host vehicle can overtake or not may be determined in combination with the velocity of the host vehicle.

Exemplarily, on the basis of the above embodiment, to safely complete overtaking by the user, the method further includes:

displaying an overtaking line on a display screen of the mobile terminal, and prompting a user to complete overtaking within a second preset time period.

For example, an overtaking display interface as shown in FIG. 1G may be provided on the mobile terminal.

Exemplarily, on the basis of the above embodiment, typically, the mobile terminal is equipped with two cameras, namely, a front camera and a rear camera. In order to sufficiently utilize an existing imaging performance of the mobile terminal and improve the driving security, the method further includes:

detecting a blink frequency of a user within a third preset time period in real time by employing a second image capturing device provided on the mobile terminal;

when the blink frequency exceeds a preset frequency, prompting the user to decelerate, or generating a decelerating signal and sending the decelerating signal to a processor of a host vehicle so that the processor controls the host vehicle to decelerate according to the decelerating signal;

or

detecting a blink time interval of a user in real time by employing a second image capturing device provided on the mobile terminal;

when the blink time interval exceeds a preset time interval, prompting the user to decelerate, or generating a decelerating signal and sending the decelerating signal to a processor of a host vehicle so that the processor controls the host vehicle to decelerate according to the decelerating signal.

According to statistics, a normal person blinks dozens of times every minute on average, and generally blinks once every 2 to 6 seconds, and each blink consumes 0.2 to 0.4 second. A normal adult blinks about 20 times every minute, but when eyes stare at a computer screen with rapidly-varying images or attention is relatively concentrated, the blink frequency may be decreased to 4 to 5 times every minute. However, after fatigue occurs, the blink frequency is usually increased, and the duration of each blink is accordingly extended. Therefore, the reference standard of the embodiment may be set as follows: the driver blinks about 20 times every minute under a non-fatigue state, with a blink time interval of 0.2 to 0.4 second.

Optionally, when the mobile terminal is actually placed, the rear camera may be used as a first image capturing device, and is configured to detect whether the host vehicle can overtake or not, and the front camera is used as a second image capturing device and is configured to detect whether the user is in a fatigue driving state or not. In addition, it should be understood by those skilled in the art that according to an actual placement manner of the mobile terminal, the front camera may be used as the first image capturing device and is configured to detect whether the host vehicle overtakes or not, and the rear camera is used as the second image capturing device and is configured to detect whether the user is in the fatigue driving state or not.

Where as shown in FIG. 1D, a human eye detection picture may also be displayed in a display area on a display screen of the mobile terminal.

The above embodiments perform image capturing preview from an interior of a host vehicle to an exterior of the host vehicle by employing a first image capturing device provided on a mobile terminal; perform distance recognition on an object in a preview image by employing an infrared laser focusing function of the first image capturing device; and perform driving information prompt on the host vehicle according to a recognition result. In this way, the safe-driving detection is completed by using a mobile terminal of a user, without mounting a high-cost specialized driving detection device in a host vehicle, and therefore, the above embodiments can be suitable for safe-driving detection of most vehicles as well, and have general applicability.

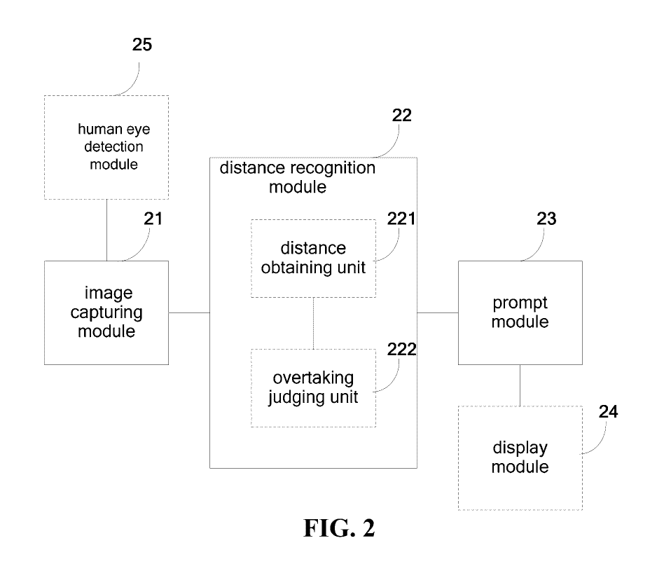

FIG. 2 is a schematic diagram of a structure showing a safe-driving detection device according to some embodiments of the present disclosure. As shown in FIG. 2, the safe-driving detection device includes an image capturing module 21, a distance recognition module 22 and a prompt module 23, where

the image capturing module 21 is configured to perform image capturing preview from an interior of a host vehicle to an exterior of the host vehicle by employing a first image capturing device provided on a mobile terminal;

the distance recognition module 22 is configured to perform distance recognition on an object in a preview image by employing an infrared laser focusing function of the first image capturing device; and

the prompt module 23 is configured to perform driving information prompt on the host vehicle according to a recognition result.

The safe-driving detection device of the embodiment of the present disclosure is configured to execute the safe-driving detection method of the above embodiments, and its technical principle and resulting technical effect are similar.

Exemplarily, on the basis of the above embodiment, the image capturing module 21 may be configured to capture an image of at least one of a front windshield, a rearview mirror and a reflective mirror from the interior of the host vehicle by employing the first image capturing device provided on the mobile terminal so as to perform image capturing preview on the exterior of the host vehicle.

Exemplarily, on the basis of the above embodiment, the distance recognition module 22 may be configured to periodically obtain a movement distance of an object external to the host vehicle in at least one direction relative to the host vehicle from the preview image by employing the infrared laser focusing function of the first image capturing device; and determine, according to a relationship between a difference between periodically obtained at least one movement distance and a preset overtaking difference, whether the host vehicle can overtake or not as a recognition result.

Exemplarily, on the basis of the above embodiment, the distance recognition module 22 includes a distance obtaining unit 221 and an overtaking judging unit 222;

the distance obtaining unit 221 is configured to obtain a movement distance of the object external to the host vehicle in at least one direction relative to the host vehicle within a first preset time period from the preview image by employing the infrared laser focusing function of the first image capturing device; and

the overtaking judging unit 222 is configured to determine a movement velocity of the object external to the host vehicle according to the movement distance, and determine, according to the movement velocity of the object external to the host vehicle, whether the host vehicle can overtake or not as a recognition result.

Exemplarily, on the basis of the above embodiment, the distance obtaining unit 221 may be configured to detect a first distance S1 of the object external to the host vehicle relative to the host vehicle at a first time T1 by employing the infrared laser focusing function of the first image capturing device; continuously detect a corresponding second time T2 when the object external to the host vehicle moves to a second distance S2 relative to the host vehicle by employing the infrared laser focusing function of the first image capturing device; and a movement distance of the object external to the host vehicle in at least one direction relative to the host vehicle within a time period (T2−T1) is (S2−S1) is obtained by calculation.

Exemplarily, on the basis of the above embodiment, the overtaking judging unit 222 may be configured to, when the object external to the host vehicle is in front of the host vehicle, calculate a relative velocity V2 of the object external to the host vehicle according to the first time T1, the first distance S1, the second distance S2 and the second time T2; if the velocity V2 is a positive value and greater than or equal to a first preset velocity threshold, it is determined that the host vehicle can overtake; and if the velocity V2 is a positive value or the velocity V2 is a negative value and an absolute value of the velocity V2 is less than the first preset velocity threshold, it is determined that the host vehicle cannot overtake.

Exemplarily, on the basis of the above embodiment, the overtaking judging unit 222 may be configured to, when the object external to the host vehicle is in rear of the host vehicle, calculate a relative velocity V2 of the object external to the host vehicle according to the first time T1, the first distance S1, the second distance S2 and the second time T2, that is,

$$V 2 = \frac{S 2 - S 1}{T 2 - T 1} ;$$

if the velocity V2 is a negative value and an absolute value of the velocity V2 is less than or equal to a second preset velocity threshold, it is determined that the host vehicle can overtake; and if the velocity V2 is a positive value or the velocity V2 is a negative value and an absolute value of velocity V2 is greater than the second preset velocity threshold, it is determined that the host vehicle cannot overtake.

Exemplarily, on the basis of the above embodiment, the device further includes a display module 24;

the display module 24 is configured to display an overtaking line on a display screen of the mobile terminal, and prompt a user to complete overtaking within a second preset time period.

Exemplarily, on the basis of the above embodiment, the image capturing module 21 is further configured to divide a display screen of the mobile terminal into at least two image capturing preview areas relative to the objects external to a host vehicle in multiple directions of the host vehicle for respective monitoring.

Exemplarily, on the basis of the above embodiment, the device further includes a human eye detection module 25;

the human eye detection module 25 is configured to detect a blink frequency of a user within a third preset time period in real time by employing a second image capturing device provided on the mobile terminal; when the blink frequency exceeds a preset frequency, prompt the user to decelerate, or generate a decelerating signal and send the decelerating signal to a processor of the host vehicle so that the processor controls the host vehicle to decelerate according to the decelerating signal; or detect a blink time interval of the user in real time by employing a second image capturing device provided on a mobile terminal; when the blink time interval exceeds a preset time interval, prompt the user to decelerate, or generate a decelerating signal and send the decelerating signal to a processor of the host vehicle so that the processor controls the host vehicle to decelerate according to the decelerating signal.

The safe-driving detection device of the above embodiments is used to execute the safe-driving detection method of the above embodiments, and its technical principle and resulting technical effects are similar.

An embodiment of the present application provides a non-transitory computer storage medium storing one or more modules, where the one or more modules enable a mobile terminal to execute any one of the methods in the above embodiments when being executed by the mobile terminal of a safe-driving detection method.

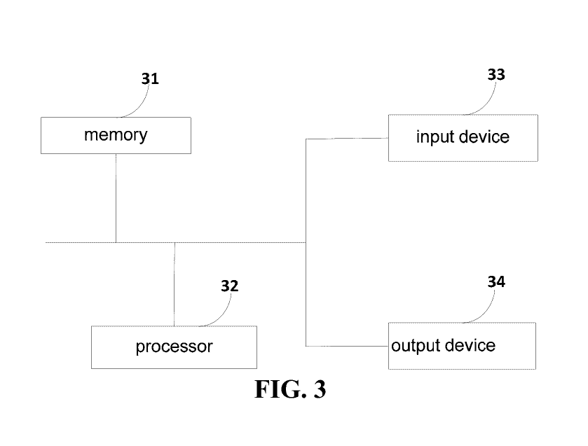

FIG. 3 is a schematic diagram showing a structure of hardware of a mobile terminal according to some embodiments of the present disclosure. As shown in FIG. 3, the smart terminal includes:

one or more processors 31 and a memory 32, where one processor 31 exemplified in FIG. 3 is taken as an example.

The smart terminal may further include an input device 33 and an output device 34.

The processor 31, the memory 32, the input device 33 and the output device 34 in the smart terminal may be connected by buses or any other means, and exemplified in FIG. 3 is a bus connection.

The memory 32, serving as a non-transitory computer-readable storage medium, may be used to store software programs, computer-executable programs and modules, such as program instructions/modules (for example, an image capturing module 21, a distance recognition module 22 and a prompt module 23 as shown in FIG. 2) corresponding to a safe-driving detection method in the embodiments of the present application. The processor 31 executes various functional applications of a server and data processing by running the software program, the instructions and the modules which are stored in the memory 32, that is, the safe-driving detection method of the above method embodiments is realized.

The memory 32 may include a program storage area and a data storage area, where the program storage area may store an operating system, and at least one application required for a function; the data storage area may store data created according to the use of the terminal device, and the like. In addition, the memory 32 may include a high-speed random access memory, and may further include a non-transitory memory, for example, at least one magnetic disk memory device, a flash memory device, or other non-transitory solid-state memory devices. In some embodiments, the memory 32 optionally includes memories remotely disposed relative to the processor 31, and these memories remotely disposed may be connected to the terminal device through a network. Examples of the above network include but not limited to Internet, Intranet, a local area network, a mobile communication network and a combination thereof.

The input device 33 may be used to receive inputted digital or character information, and produce a key signal input associated with user setting and function control of the terminal. The output device 34 may include display devices such as a display screen.

The one or more modules are stored in the memory 32, and execute any one of the methods in the above embodiments when being executed by the one or more processors 31.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as IPHONE), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as IPAD;

(3) portable entertainment device. A device of this kind can display and play multi-media content. Devices of this kind include audio and video player (such as IPOD), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make the corresponding technical solutions depart from spirits and scope of technical solutions of various embodiments.

It is noted that the foregoing is merely preferred embodiments of the present disclosure and the applied technical principle. It will be understood by those skilled in the art that the present disclosure is not limited to the embodiments described herein, but may include more other equivalent embodiments, and the scope of the present disclosure is determined by the scope of appended claims.

What is claimed is:

1. A driving detection method, comprising:
performing image capturing preview on an exterior of a host vehicle from an interior of the host vehicle by employing a first image capturing device provided on a mobile terminal;
performing distance recognition on an object in a preview image by employing an infrared laser focusing function of the first image capturing device; and
performing driving information prompt on the host vehicle according to a recognition result.

2. The method according to claim 1, wherein the performing image capturing preview on an exterior of a host vehicle from an interior of the host vehicle by employing a first image capturing device provided on a mobile terminal comprises:
capturing an image of at least one of a front windshield, a rearview mirror and a reflective mirror from an interior of the host vehicle by employing a first image capturing device provided on a mobile terminal so as to perform image capturing preview on an exterior of the host vehicle.

3. The method according to claim 1, wherein the performing distance recognition on an object in a preview image by employing an infrared laser focusing function of the first image capturing device comprises:
obtaining a movement distance of an object external to a host vehicle in at least one direction relative to the host vehicle from the preview image periodically by employing an infrared laser focusing function of the first image capturing device; and
determining, according to a relationship between a difference between multiple movement distances periodically obtained in the same one direction and a preset overtaking difference, whether the host vehicle can overtake or not as a recognition result.

4. The method according to claim 1, wherein the performing distance recognition on an object in a preview image by employing an infrared laser focusing function of the first image capturing device comprises:
obtaining a movement distance of an object external to a host vehicle in at least one direction relative to the host vehicle within a first preset time period from the preview image by employing an infrared laser focusing function of the first image capturing device; and
determining a movement velocity of the object external to the host vehicle according to the movement distance, and determining, according to the movement velocity of the object external to the host vehicle, whether the host vehicle can overtake or not as a recognition result.

5. The method according to claim 4, wherein the obtaining a movement distance of an object external to a host vehicle in at least one direction relative to the host vehicle within a first preset time period from the preview image by employing an infrared laser focusing function of the first image capturing device comprises:
detecting a first distance S1 of the object external to the host vehicle relative to the host vehicle at a first time T1 by employing an infrared laser focusing function of the first image capturing device;
continuously detecting, by employing an infrared laser focusing function of the first image capturing device, a corresponding second time T2 when the object external to the host vehicle moves to a second distance S2 relative to the host vehicle; and
a movement distance of the object external to the host vehicle in at least one direction relative to the host vehicle within a time period (T2−T1) is (S2−S1).

6. The method according to claim 5, wherein the determining a movement velocity of the object external to the host vehicle according to the movement distance, and determining, according to the movement velocity of the object external to the host vehicle, whether the host vehicle can overtake or not as a recognition result comprises:
when the object external to the host vehicle is in front of the host vehicle, calculating a relative velocity V2 of the object external to the host vehicle according to the first time T1, the first distance S1, the second distance S2 and the second time T2, that is,
$$V 2 = \frac{S 2 - S 1}{T 2 - T 1} ;$$
if the velocity V2 is a positive value and greater than or equal to a first preset velocity threshold, determining that the host vehicle can overtake; and
if the velocity V2 is a positive value or the velocity V2 is a negative value and an absolute value of the velocity V2 is less than the first preset velocity threshold, determining that the host vehicle cannot overtake.

7. The method according to claim 5, wherein the determining a movement velocity of the object external to the host vehicle according to the movement distance, and determining, according to the movement velocity of the object external to the host vehicle, whether the host vehicle can overtake or not as a recognition result comprises:
when the object external to the host vehicle is in rear of the host vehicle, calculating a relative velocity V2 of the object external to the host vehicle according to the first time T1, the first distance S1, the second distance S2 and the second time T2, that is,
$$V 2 = \frac{S 2 - S 1}{T 2 - T 1} ;$$
if the velocity V2 is a negative value and an absolute value of the velocity V2 is less than or equal to a second preset velocity threshold, determining that the host vehicle can overtake; and
if the velocity V2 is a positive value or the velocity V2 is a negative value and an absolute value of the velocity V2 is greater than the second preset velocity threshold, determining that the host vehicle cannot overtake.

8. The method according to claim 5, further comprising:
displaying an overtaking line on a display screen of the mobile terminal, and prompting a user to complete overtaking within a second preset time period.

9. The method according to claim 1, further comprising:
dividing a display screen of the mobile terminal into at least two image capturing preview areas relative to objects external to a host vehicle in multiple directions of the host vehicle for respective monitoring.

10. The method according to claim 1, further comprising:
detecting a blink frequency of a user within a third preset time period in real time by employing a second image capturing device provided on a mobile terminal;
when the blink frequency exceeds a preset frequency, prompting the user to decelerate, or generating a decelerating signal and sending the decelerating signal to a processor of a host vehicle so that the processor controls the host vehicle to decelerate according to the decelerating signal; or,
detecting a blink time interval of a user in real time by employing a second image capturing device provided on a mobile terminal;
when the blink time interval exceeds a preset time interval, prompting the user to decelerate, or generating a decelerating signal and sending the decelerating signal to a processor of a host vehicle so that the processor controls the host vehicle to decelerate according to the decelerating signal.

11. An electronic device for safe-driving detection, comprising at least one processor and a memory communicably connected with the at least one processor for storing instructions executable by the at least one processor, wherein execution of the instructions by the at least one processor causes the at least one processor to:
perform image capturing preview on an exterior of a host vehicle from an interior of the host vehicle by employing a first image capturing device provided on a mobile terminal;
perform distance recognition on an object in a preview image by employing an infrared laser focusing function of the first image capturing device; and
perform driving information prompt on the host vehicle according to a recognition result.

12. The electronic device according to claim 11, wherein when the performing image capturing preview on an exterior of a host vehicle from an interior of the host vehicle by employing a first image capturing device provided on a mobile terminal, the executable instructions further cause the electronic device to:
capture an image of at least one of a front windshield, a rearview mirror and a reflective mirror from an interior of a host vehicle by employing a first image capturing device provided on a mobile terminal so as to perform image capturing preview on an exterior of the host vehicle.

13. The electronic device according to claim 11, wherein when the performing distance recognition on an object in a preview image by employing an infrared laser focusing function of the first image capturing device, the executable instructions further cause the electronic device to:
obtain a movement distance of an object external to a host vehicle in at least one direction relative to the host vehicle from the preview image periodically by employing an infrared laser focusing function of the first image capturing device; and determine, according to a relationship between a difference between at least one movement distance periodically obtained and a preset overtaking difference, whether the host vehicle can overtake or not as a recognition result.

14. The electronic device according to claim 11, wherein when the performing distance recognition on an object in a preview image by employing an infrared laser focusing function of the first image capturing device, the executable instructions further cause the electronic device to:
obtain a movement distance of an object external to a host vehicle in at least one direction relative to the host vehicle within a first preset time period from the preview image by employing an infrared laser focusing function of the first image capturing device; and
determine a movement velocity of the object external to the host vehicle according to the movement distance, and determine, according to the movement velocity of the object external to the host vehicle, whether the host vehicle can overtake or not as a recognition result.

15. The electronic device according to claim 14, wherein when the performing distance recognition on an object in a preview image by employing an infrared laser focusing function of the first image capturing device, the executable instructions further cause the electronic device to:
detect a first distance S1 of the object external to the host vehicle relative to the host vehicle at a first time T1 by employing an infrared laser focusing function of the first image capturing device;
continuously detect, by employing an infrared laser focusing function of the first image capturing device, a corresponding second time T2 when the object external to the host vehicle moves to a second distance S2 relative to the host vehicle; and
make a movement distance of the object external to the host vehicle in at least one direction relative to the host vehicle within a time period (T2−T1) to be (S2−S1).

16. The electronic device according to claim 15, wherein when the performing distance recognition on an object in a preview image by employing an infrared laser focusing function of the first image capturing device, the executable instructions further cause the electronic device to:
when the object external to the host vehicle is in front of the host vehicle, calculate a relative velocity V2 of the object external to the host vehicle according to the first time T1, the first distance S1, the second distance S2 and the second time T2;
if the velocity V2 is a positive value and greater than or equal to a first preset velocity threshold, it is determined that the host vehicle can overtake; and
if the velocity V2 is a positive value or the velocity V2 is a negative value and an absolute value of the velocity V2 is less than the first preset velocity threshold, it is determined that the host vehicle cannot overtake.

17. The electronic device according to claim 15, wherein when the performing distance recognition on an object in a preview image by employing an infrared laser focusing function of the first image capturing device, the executable instructions further cause the electronic device to:
when the object external to the host vehicle is in rear of the host vehicle, calculate a relative velocity V2 of the object external to the host vehicle according to the first time T1, the first distance S1, the second distance S2 and the second time T2;
if the velocity V2 is a negative value and an absolute value of velocity V2 is less than or equal to a second preset velocity threshold, it is determined that the host vehicle can overtake; and
if the velocity V2 is a positive value or the velocity V2 is a negative value and an absolute value of velocity V2 is greater than the second preset velocity threshold, it is determined that the host vehicle cannot overtake.

18. The electronic device according to claim 15, wherein execution of the instructions by the at least one processor further causes the at least one processor to:
display an overtaking line on a display screen of the mobile terminal, and prompt a user to complete overtaking within a second preset time period.

19. The electronic device according to claim 11, wherein when the performing image capturing preview on an exterior of a host vehicle from an interior of the host vehicle by employing a first image capturing device provided on a mobile terminal, the executable instructions further cause the electronic device to:
divide a display screen of the mobile terminal into at least two image capturing preview areas relative to objects external to a host vehicle in multiple directions of the host vehicle for respective monitoring.

20. A non-transitory computer-readable storage medium storing executable instructions that, when executed by an electronic device, cause the electronic device to:
perform image capturing preview on an exterior of a host vehicle from an interior of the host vehicle by employing a first image capturing device provided on a mobile terminal;
perform distance recognition on an object in a preview image by employing an infrared laser focusing function of the first image capturing device; and
perform driving information prompt on the host vehicle according to a recognition result.
